(19) United States
(12) Patent Application Publication
(10) Pub. No.: US 2006/0150838 A1
(43) Pub. Date: Jul. 13, 2006

(54) Printing press

(75) Inventors: Tony Hollings, Lancashire (GB); John McCrone, Lancashire (GB); Arthur Lamb, Lancashire (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Goss Graphic Systems Limited, Preston, Lancashire (GB)

(21) Appl. No.: 10/563,639

(22) PCT Filed: Jul. 7, 2004
(86) PCT No.: PCT/GB04/02920

§ 371 Date: Jan. 6, 2006

(30) Foreign Application Priority Data
Jul. 8, 2003 (GB) 0315986.0
Apr. 8, 2004 (GB) 0408085.9

(51) Int. Cl. B41F 5/18

(52) U.S. Cl. 101/180

(57) ABSTRACT

A printing unit for a web-offset press is disclosed. The printing unit comprises plate and blanket cylinders arranged in couples to print on both sides of a paper web passing between each pair of print couples, and an inking system associated with each print couple when the printing unit is in an operative position operable to supply ink to the plate cylinder. The printing unit is separable into a primary module carrying the plate and blanket cylinders and a pair of secondary modules carrying the inking systems. Other aspects of the invention include a printing press and a folder unit for use in a printing press.

The present invention relates to a printing unit, a printing press and a folder used in such a press. One particular aspect of the invention relates to a modular flexible web-offset printing unit that enables the printed image cut-off to be varied in addition or alternatively to providing improved access to all parts of the unit for maintenance, repair and for setting up prior to initiating a new print run. Another aspect of the invention relates to a printing press and to the layout or orientation of the printing unit or units relative to a folder. A further aspect of the invention relates to the construction of a folder for use in a web-offset printing press.

A web-offset rotary printing press comprises a number of printing units designed to print matter onto separate continuous webs of a print medium, such as paper, travelling through each print unit. Each unit contains at least one pair of cylinder groups or print couples comprising a rotatably mounted plate cylinder, to which one or more printing plates are attached, and a rotatably mounted blanket cylinder. Many presses of this type incorporate a shaftless drive system in which each cylinder group is driven by its own drive motor which directly drives one of the cylinders of the group via a belt or gear drive. The cylinders within each cylinder group are typically coupled mechanically so that drive is transferred from the directly driven cylinder to the other cylinder of that group. An inking system associated with each print couple and comprising a train of ink rollers is operable to feed ink onto the printing plates as the plate cylinder rotates. As the cylindrical surfaces of the plate and blanket cylinder are in rolling contact, an inked image is transferred onto the blanket cylinder from the plate cylinder and, from the blanket cylinder, to the print medium generally comprising a web of paper passing between the blanket cylinder and an impression cylinder. To enable the paper web to be printed on both sides, the impression cylinder is actually the blanket cylinder of another print couple including a plate cylinder having printing plates to which ink is transferred from another inking system roller train. Therefore, it will be appreciated that a print couple is arranged on opposite sides of the paper web which runs between them.

Each printing unit comprises a frame to which each print couple and its respective inking system are mounted. The printing unit may also comprise a dampening system associated with each inking unit also mounted to the frame. The printing units are spaced from each other and aligned with a folder unit so that the paper web is fed through each print unit from a separate reelstand mounted below or to one side of each printing unit at floor level and then travels in a lateral direction away from the unit and into the folder. A slitting mechanism for cutting the web into separate ribbons and turner bars for turning one or more of the ribbons to orientate them before they enter the folder are located between the print unit and the folder.

In large scale high volume presses used, for example, in the printing of newspapers, multi-colour printing is achieved by providing each printing unit with a number of printing couple pairs mounted vertically one above the other in a stack so that the paper web travels in a vertically upward direction between each pair of print couples from the reelstand. A unit having four printing couple pairs, i.e. eight print couples, is able to print up to four colours on each side of the paper web and is often known as a “four-high” unit. A unit having a different number of print couple pairs is also possible depending on the application to which the press is to be put and the quality and number of colours to be printed. For example, a “five-high” unit having five print couple pairs is also known. When a printed web emerges from the upper end of each print unit it is passed over a roller having an axis of rotation at right angles to the direction of travel of the web. As the web passes over the roller its upward direction of travel is changed so that it now travels in a lateral direction along the press and towards the folder. Depending on the configuration of the press, the webs are slit and turned by passing them over turner bars angled at 45 degrees to the direction of travel of the web before they enter the folder, as will be explained in more detail below.

In conventional presses, each printing unit has a plate and a blanket cylinder with a fixed diameter. It will be appreciated that the diameter of these cylinders dictates the printed image cut-off which is the maximum length of the image that can be printed by the printing unit. In a one-around press or a press in which the image to be applied to one page is transferred to the blanket cylinder in one revolution of the plate cylinder, the maximum length of the printed page cannot exceed the circumference or slightly less than the circumference of the plate and blanket cylinders or, in a two-around press, where the image to be applied to two pages is transferred to the blanket cylinder in one revolution of the plate cylinder, the maximum height of the printed page cannot exceed half the circumference of the cylinders.

It is a very difficult and time consuming task to alter the cut-off because it is fundamental to the size and geometry of the printing and folding machines and essentially involves changing the plate and blanket cylinders for cylinders of a different diameter as well as replacing or altering the position of many of the other components of the printing unit or press, including the cylinders of the folder which cut the webs into each copy and must change size to vary the cut-off, i.e. the length of the copy that the webs are cut into. This generally necessitates a complete strip-down and reassembly of the or each printing unit and the folder. Not only is this a very expensive operation to perform but it is particularly undesirable because it involves a considerable amount of time during which the press remains inoperable. Consequently, this has a significant negative affect on the overall productivity of the press. In fact, many press operators simply cannot afford to shut down the press for such lengthy periods of time due to increased demand for printed matter and the very tight deadlines which must be met. Therefore, the printed image cut-off achievable with a particular printing press is generally regarded as being fixed so the size of the newspaper that can be printed using that press is limited. The inability to change the cut-off of a conventional press, or the inability to do so rapidly and easily, has severely limited the desired flexibility that this type of press would otherwise be able to offer. Press manufacturers therefore have to offer different presses, including printing units and folders, in a range of specific cut-off sizes to meet customer demand.

In addition to the problems described above, a conventional printing press also suffers from a number of other disadvantages that reduces its operational time and hinders its flexibility. Very short deadlines and high demand often means that the press must be run continually over long periods of time. However, delays occur due to the time it takes for the press to be made ready for a new print job when the previous print job has been completed. For example, to plate-up the press, individual printing plates on each printing cylinder of each printing couple must be replaced. This is a time consuming task especially as access to the plate cylinders may be limited by other components such as the inking and/or dampening mechanism which get in the way. It will also be appreciated that in a four high printing unit, the printing plates may need to be replaced on eight plate cylinders before initiating a new print run with that printing unit. In addition, the press may comprise several printing units all of which require plating-up before initiating a new print run using all the printing units. Experience has shown that it can take at least 45 minutes for one person to replace the printing plates on a single four-high printing unit.

It will also be appreciated that individual printing units or specific couples within each unit require regular attention for the purposes of maintenance and/or repair. However, the inaccessibility of certain components means that the printing unit often has to be stripped down to gain access to the failed component or for cleaning and this significantly increases the down time of the press.

The aforementioned problems are exacerbated by the structural height of each printing unit making access to the higher print couples and their associated components for plating-up and maintenance even more complicated in addition to requiring larger and more expensive buildings to contain them. Furthermore, as the print couple pairs are stacked one above the other, the paper web to be printed must travel over a comparatively long distance between points at which different coloured ink are printed onto the web. This can lead to problems in maintaining registration of the printed image and increases waste when the press is stopped, during plate changes and when the press is restarted. It will also be noted that a printing unit of greater height has a corresponding increase in weight and structural instability requiring the foundations of the press to be more heavily reinforced. Although problems caused by the height of the press and the distance between points at which the different coloured inks are printed onto the web can be alleviated by the use of a satellite press in which a number of cylinder groups are arranged around a central impression cylinder, this type of press is mechanically very complicated and requires regular maintenance.

One aspect of the present invention also addresses the problem of maintaining equal tension in the web when it has been slit to form two or more separate ribbons and one or more of the ribbons is moved by passing it over turner bars so that they can be fed over the same former in the folder. Ideally, the tension in each ribbon is kept the same and remains constant. However, this is very difficult to achieve in practice, especially when the direction of one or some of the ribbons is changed more than the direction of other ribbons because of the friction generated between the ribbon and a turner bar as the ribbon slides over it. It will be appreciated that a constant and equal web tension is important from the point of view of both maintaining registration in the printed image across the page and achieving good press runability with a minimum of web breaks. This problem and the proposed reconfiguration of the press to alleviate or solve it will be addressed further below.

It is an object of the present invention to overcome or substantially alleviate the problems with a conventional printing unit, press and/or folder, many of which have been described in more detail above. Many of the modifications proposed by the invention can be used independently to overcome some of the aforementioned problems. However, it is also envisaged that the modifications can all be employed together in the same press to maximise the overall flexibility such a press would provide.

According to a first aspect of the invention, there is provided a printing unit for a web-offset press comprising plate and blanket cylinders arranged in couples to print on both sides of a paper web passing between them, and an inking system associated with each print couple when the printing unit is in an operative position operable to supply ink to the plate cylinder thereof, wherein the printing unit is separable into a primary module carrying the plate and blanket cylinders and a pair of secondary modules carrying the inking systems.

In a preferred embodiment, the printing unit includes means to enable the primary module to be replaced with a different primary module when the or each printing unit has been separated so that each inking system of the secondary modules will be associated with a respective print couple of said different primary module when the or each printing unit is returned to its operative position.

The present invention also comprises a method of reconfiguring a printing unit comprising plate and blanket cylinders carried by a primary module and inking systems carried by a pair of secondary modules, an inking system being associated with each print couple when the printing unit is in an operative position, the method comprising the steps of separating the secondary modules from the primary module and replacing the primary module with a different primary module.

In accordance with another aspect of the invention, there is provided a folder for a web-offset printing press comprising an upper folder module including at least one former to impart a first longitudinal fold to a continuous web of printed matter passing over the or each former, a lower folder module to receive the folded web from the upper folder module and comprising means to cut the web into longitudinal sections and impart a second fold to each section substantially at right angles to the first longitudinal fold and, a delivery module comprising means to receive the folded sections from the lower folder module and deliver them for transportation out of the folder, wherein the lower folder module is separable from the upper folder module. The lower folder module preferably comprises a completely separate modular unit to the upper folder module thereby enabling the lower folder module to be separated from the upper folder module and, if required, replaced with a different lower folder module.

In accordance with another aspect of the invention, there is provided a folder for a web-offset printing press comprising an upper folder module including at least one former to impart a first longitudinal fold to a continuous web of printed matter passing over the or each former, a lower folder module to receive the folded web from the upper folder module and comprising means to cut the web into longitudinal sections and impart a second fold to each section substantially at right angles to the first longitudinal fold and, a delivery module comprising means to receive the folded sections from the lower folder module and deliver them for transportation out of the folder, wherein the delivery module is separable from the lower folder module.

The present invention also provides another method of reconfiguring a folder for a web-offset printing press comprising an upper folder module including at least one former to impart a first longitudinal fold to a continuous web of printed matter passing over the or each former, a discrete lower folder module separable from the upper folder module to receive the folded web from the upper folder module and comprising means to cut the web into longitudinal sections and impart a second fold to each section substantially at right angles to the first longitudinal fold and, a delivery module comprising means to receive the folded sections from the lower folder module and deliver them for transportation out of the folder, wherein method includes the step of separating the lower folder module from the upper folder and the delivery modules and replacing the lower folder module with another lower folder module.

According to another aspect of the invention, there is provided a web-offset printing press comprising a print unit and a folder located adjacent to the print unit together defining a path for a web of paper passing through the press, the print unit comprising means for slitting the web to form a plurality of ribbons and means for turning said ribbons so that each lie in a parallel plane one above the other as they travel towards and into the folder, wherein the press is configured such that said means for turning the ribbons is operable to turn each ribbon the same number of times between the print unit and the folder.

Embodiments of the invention will now be described, by way of example only, with reference to FIGS. 1 to 3, 5 to 11 and 13 to 18 of the accompanying drawings, in which:

FIG. 1 illustrates a side cross-sectional elevation of a printing unit in a closed or operative position ready for printing according to the invention;

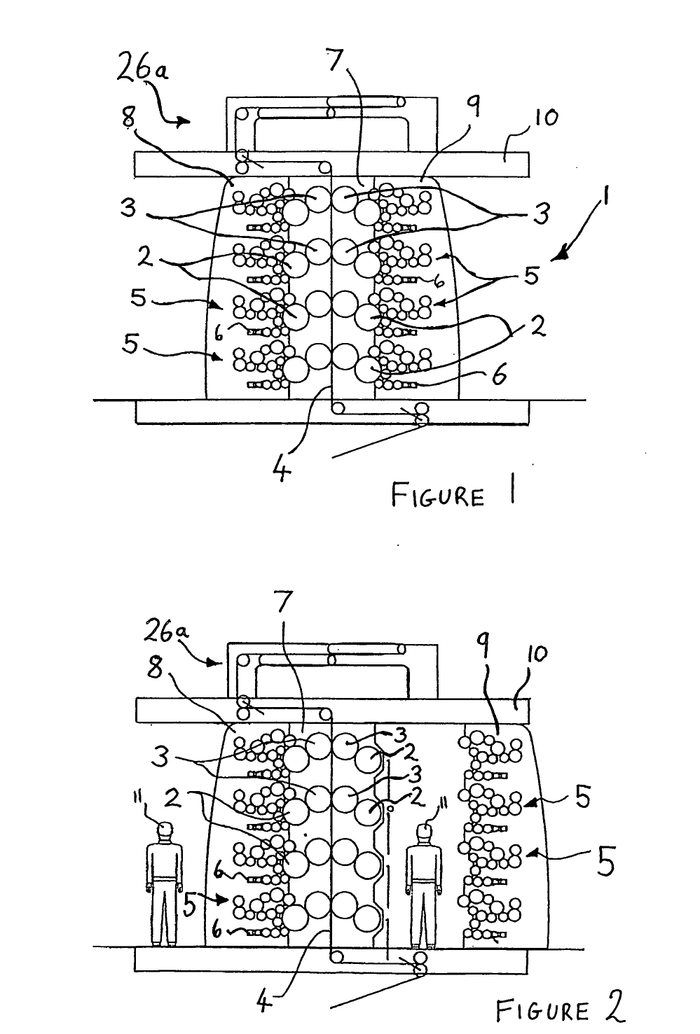

FIG. 2 illustrates a side cross-sectional elevation of the printing unit shown in FIG. 1 but in a partially open non-operative position to provide access and thereby facilitate maintenance, plating up operations such as auto-plate loading, on-press imaging and other functions;

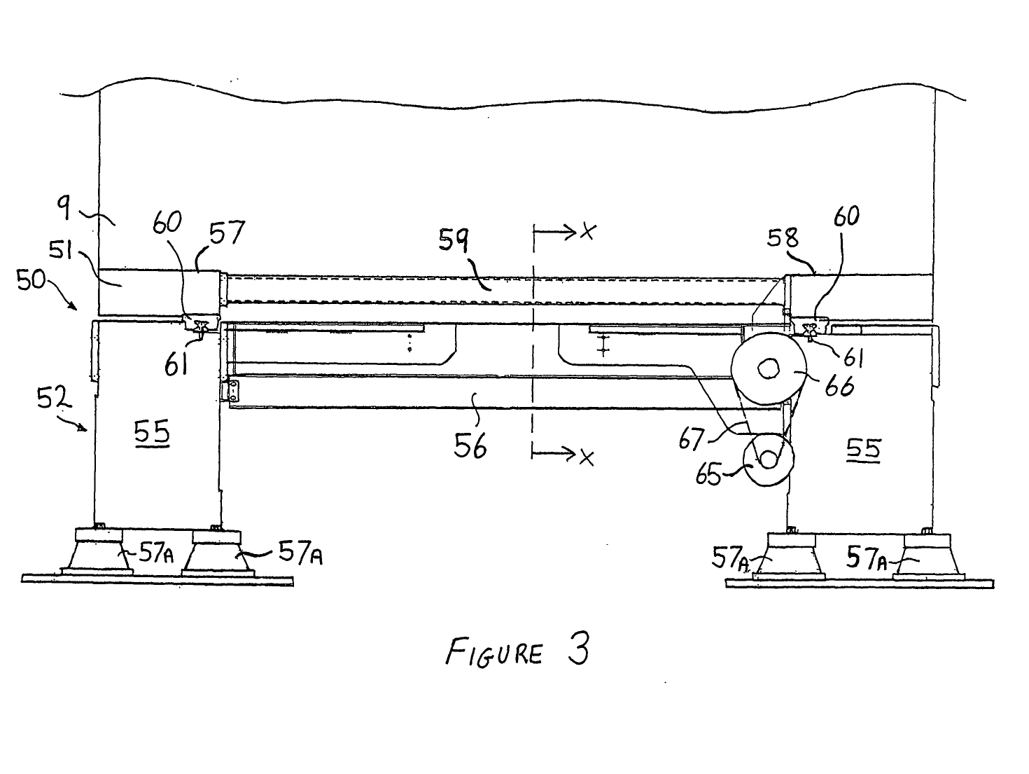

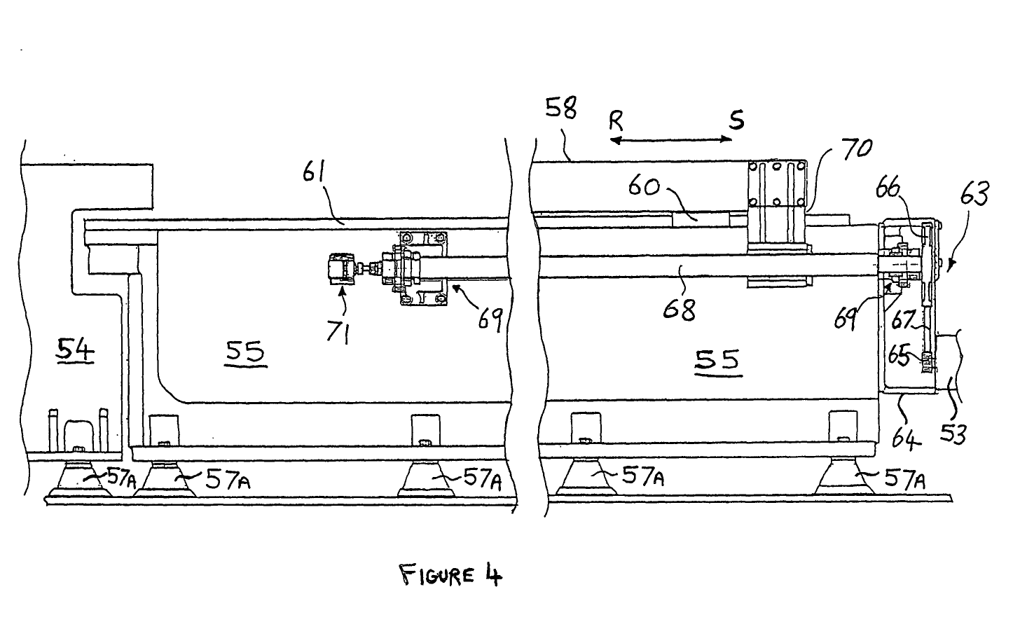

FIG. 3 is an end view of a secondary module support frame according to a preferred embodiment of the invention;

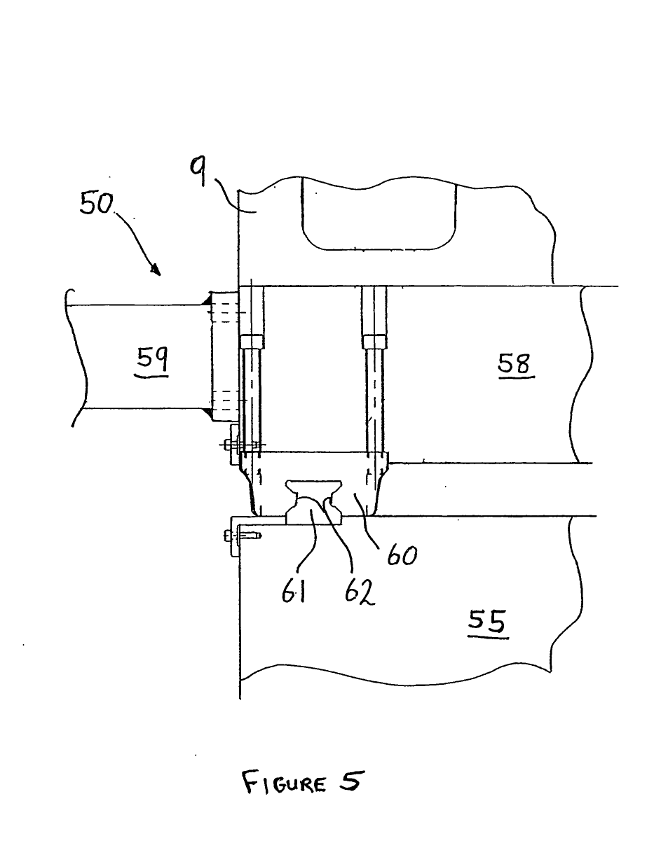

FIG. 4 is a simplified partial view along the line X-X of FIG. 3;

FIG. 5 is an enlarged partial view to show how the secondary module is mounted to the support frame;

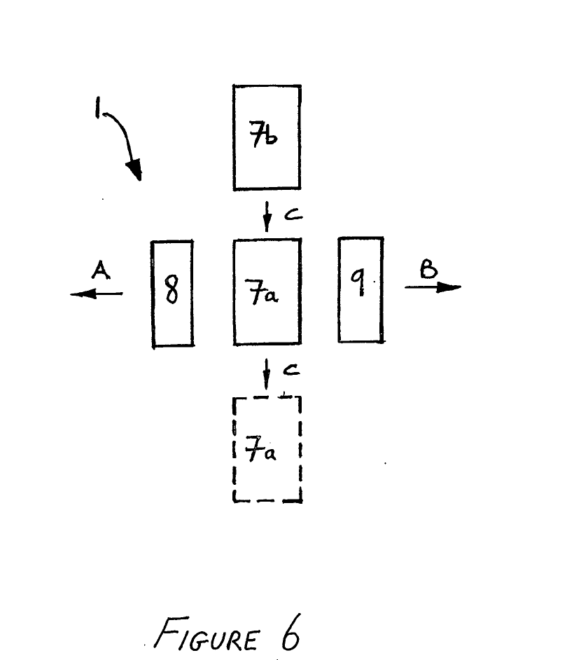

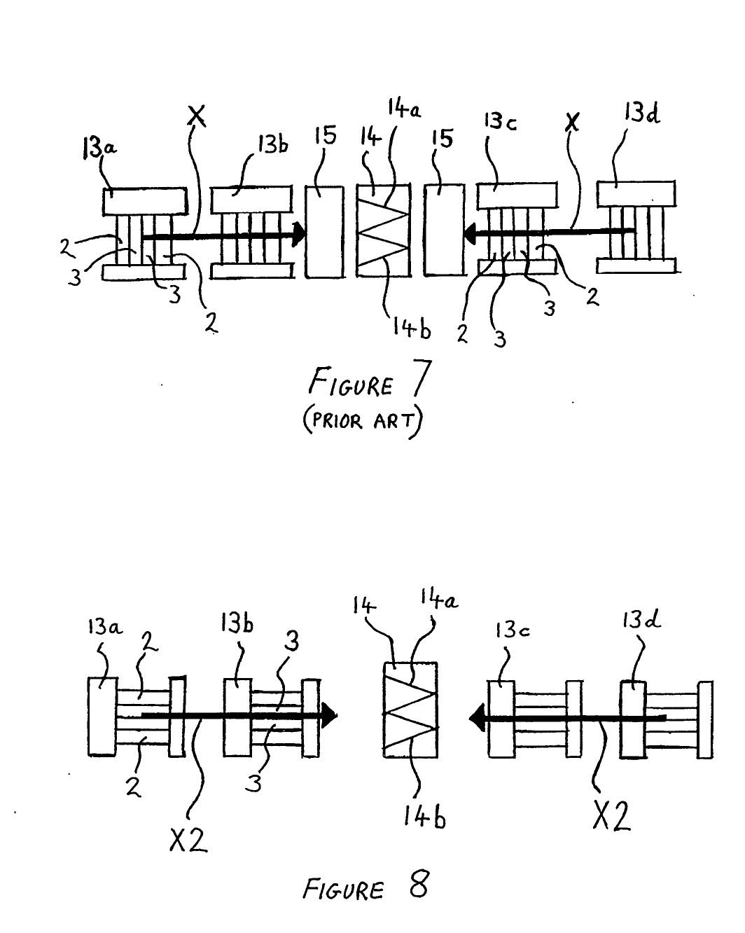

FIG. 6 illustrates a plan view of one print unit having two primary modules according to the modified version of the print unit illustrated in FIGS. 1 and 2.

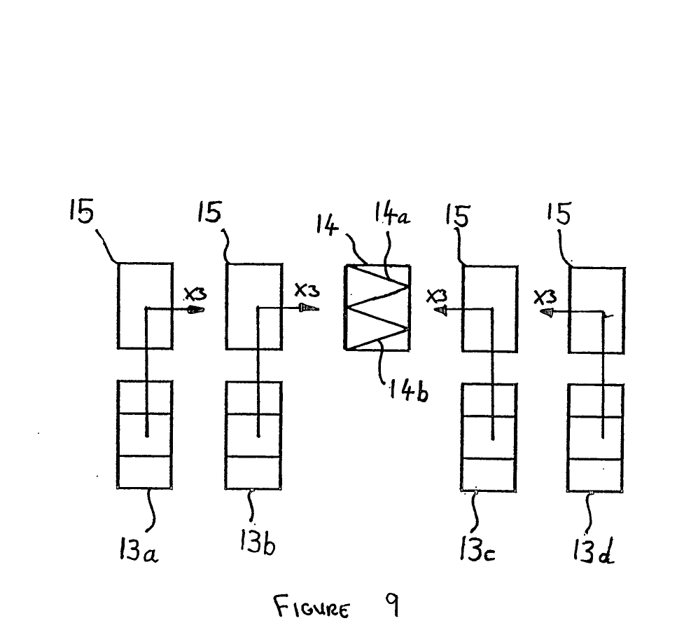

FIG. 7 illustrates a plan view of a conventional press configuration;

FIG. 8 illustrates a plan view of a press configuration according to the invention;

FIG. 9 illustrates a plan view of an alternative press configuration according to the invention;

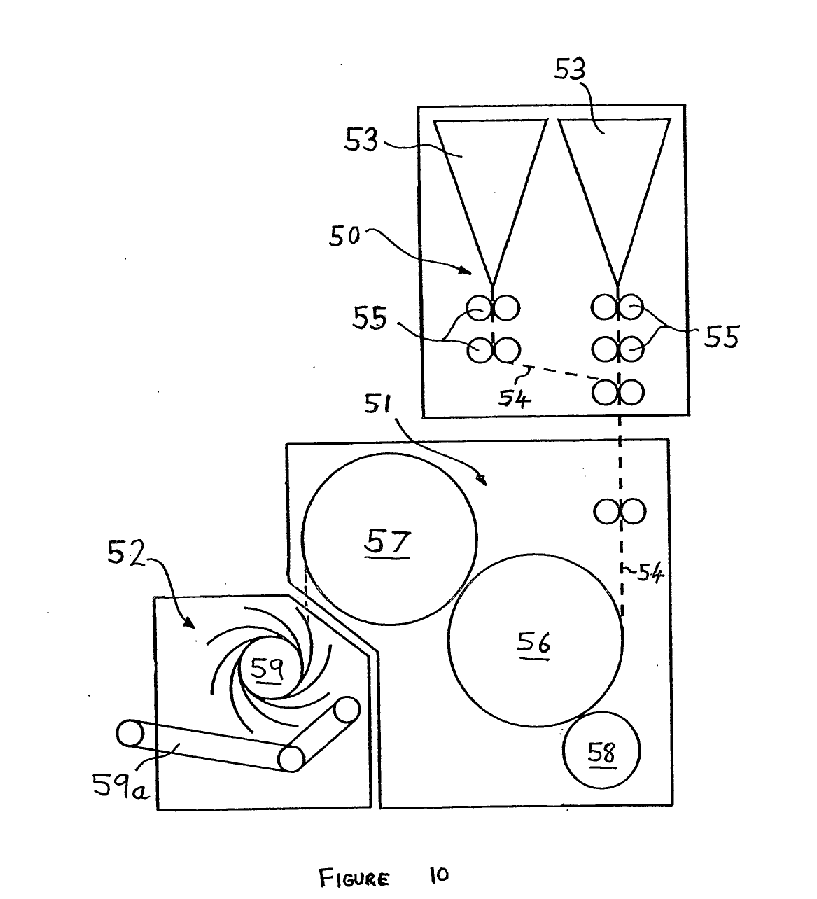

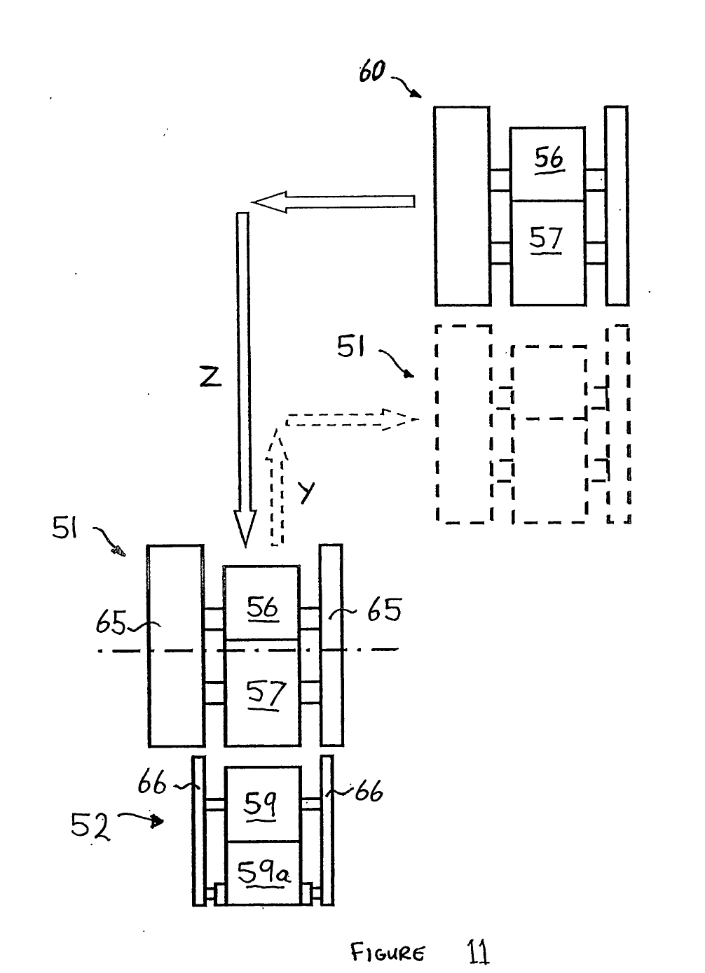

FIG. 10 illustrates a simplified side elevational view of a folder according to an aspect of the invention;

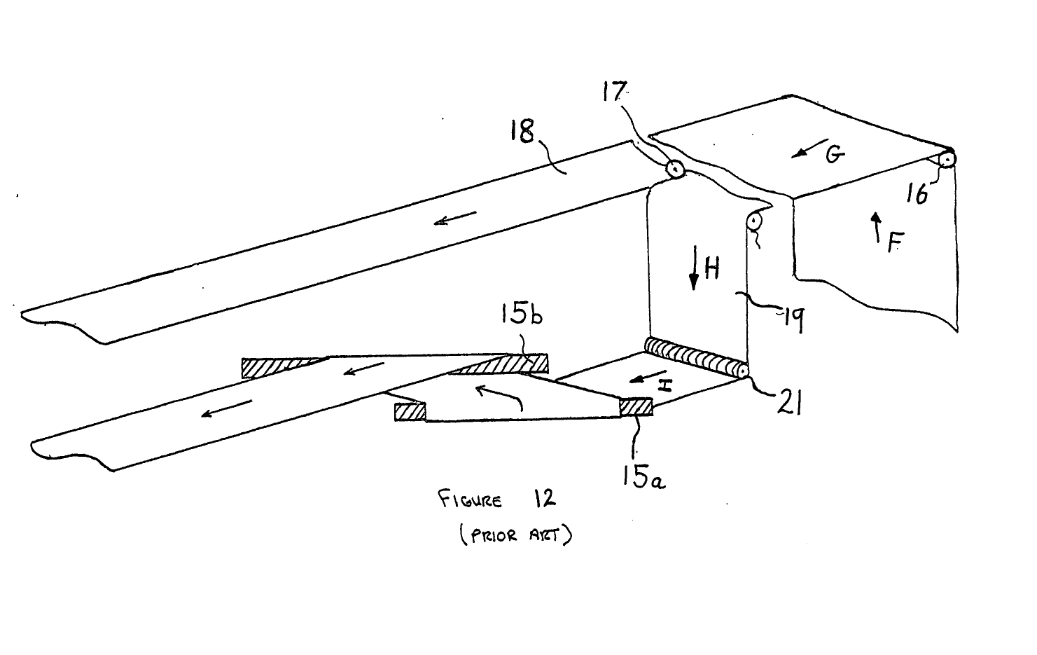

FIG. 11 illustrates a simplified plan view of the lower folder module, the delivery module and a replacement lower folder module;

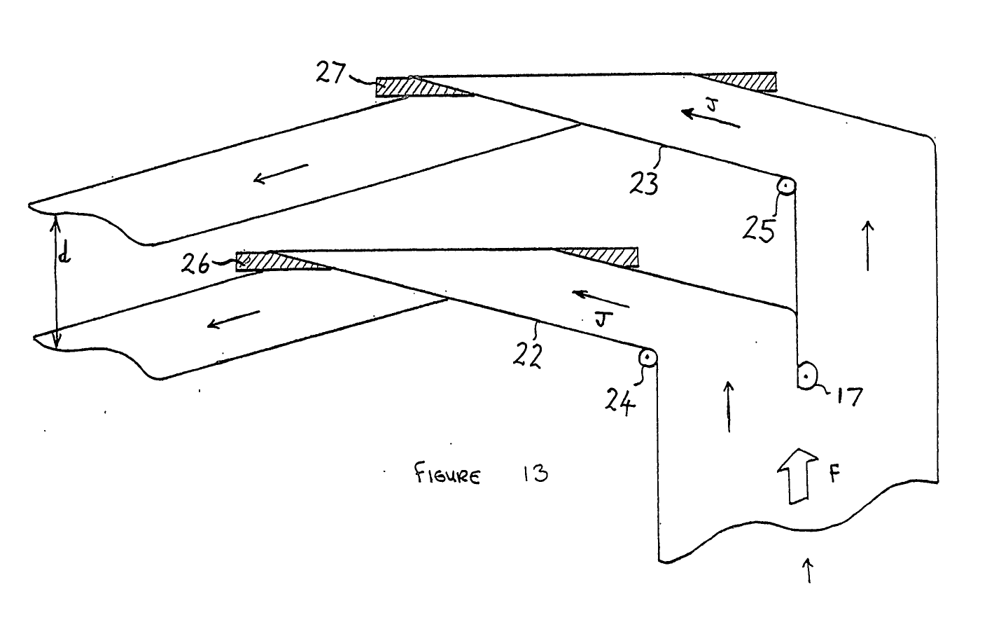

FIG. 12 illustrates a perspective view of part of a web path from one print unit to the folder according to a conventional arrangement;

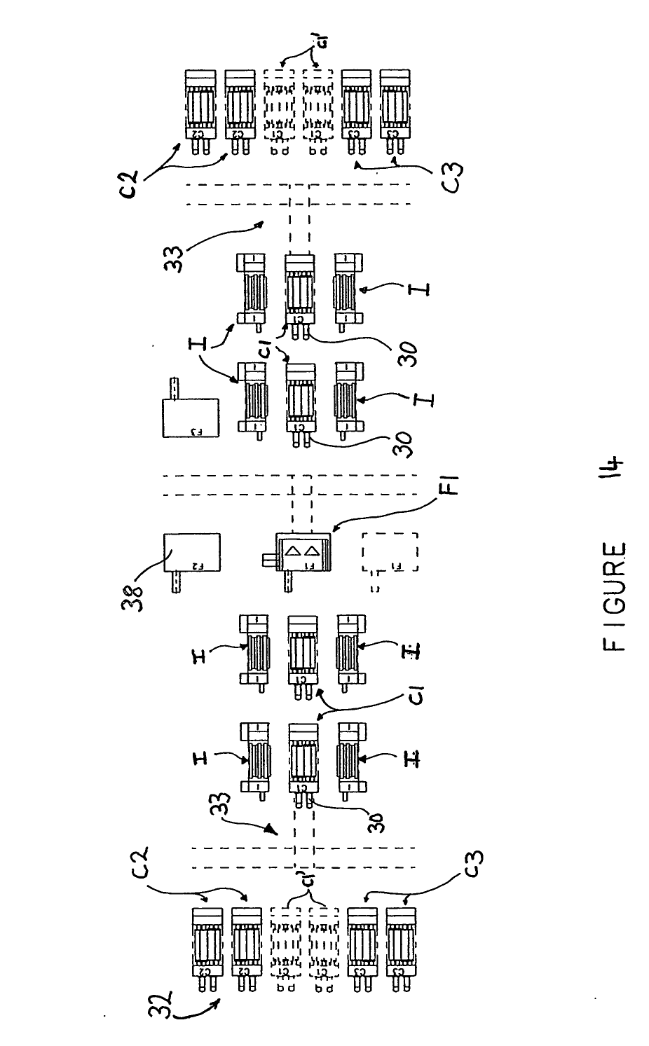

FIG. 13 illustrates a perspective view of part of a web path from one print unit to the folder according to another aspect of the invention;

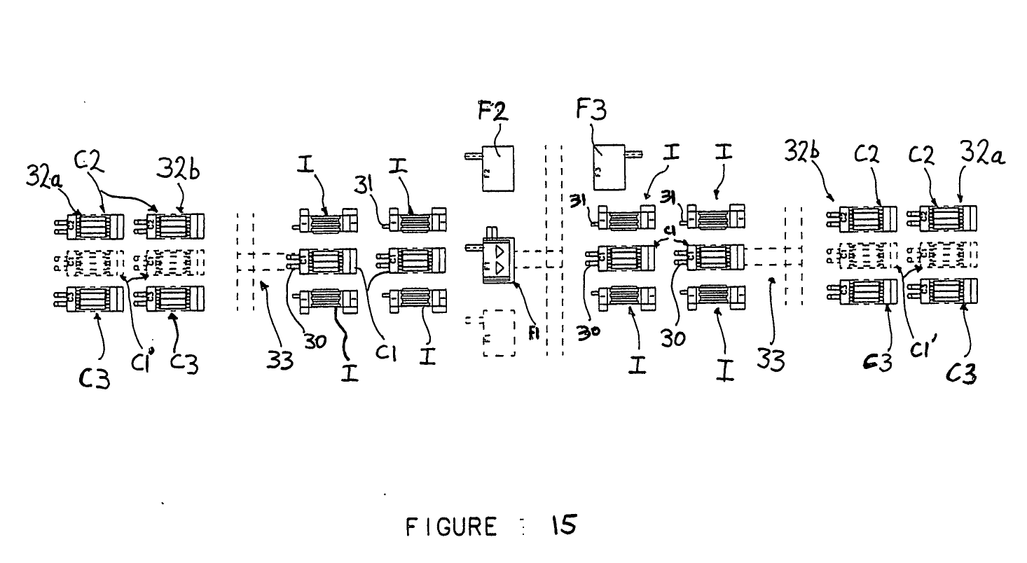

FIG. 14 illustrates a plan view of a proposed printing press configuration incorporating printing units according to one aspect of the invention;

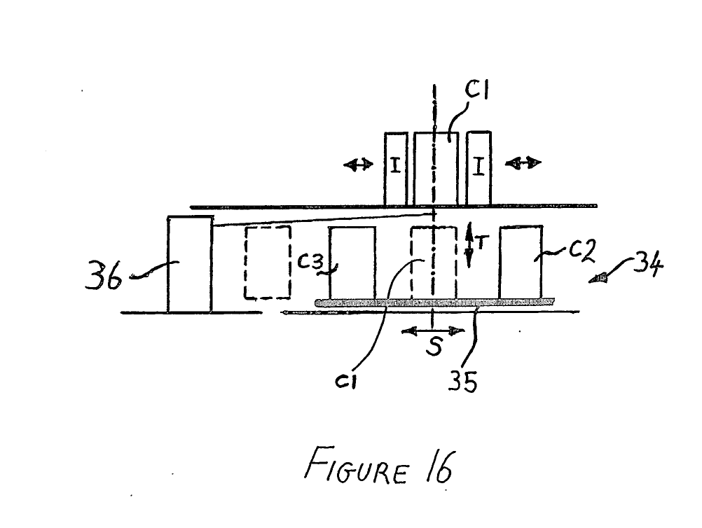

FIG. 15 illustrates an alternative printing press configuration;

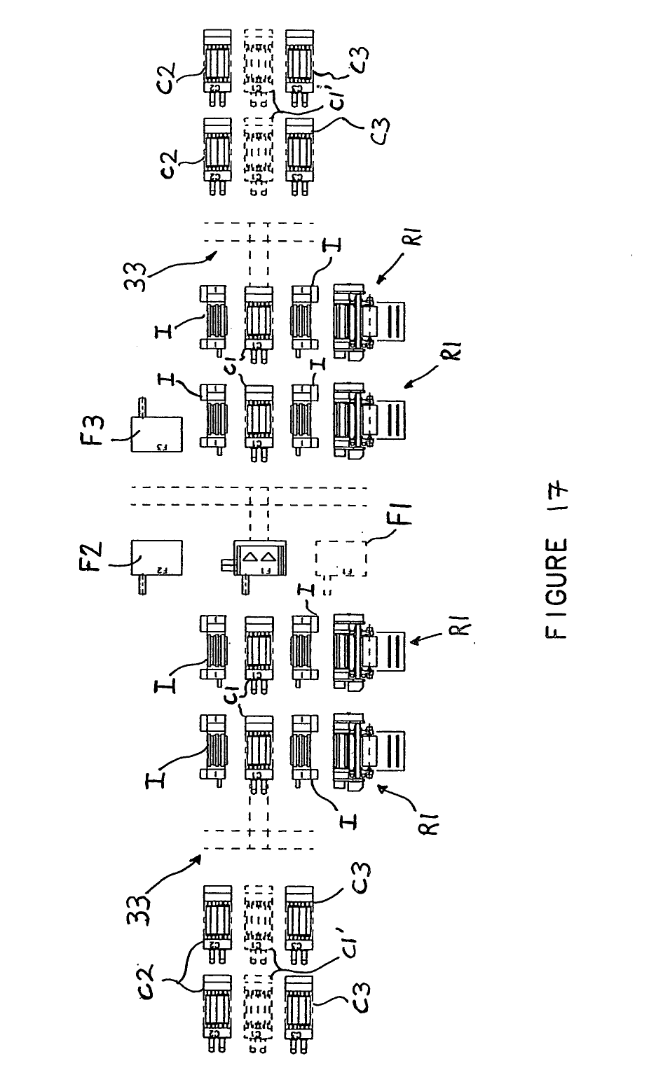

FIG. 16 illustrates yet another alternative press configuration;

FIG. 17 illustrates a modified version of the press configuration shown in FIG. 15; and

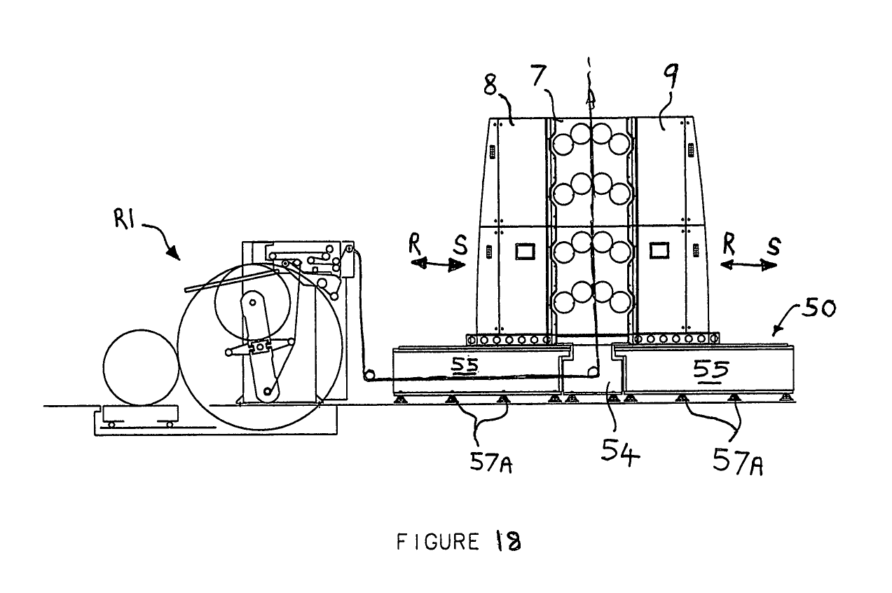

FIG. 18 illustrates a printing unit according to the present invention with a reelstand mounted adjacent to the printing unit rather than beneath it.

Referring now to the drawings, there is shown in FIG. 1 a side cross-sectional elevation of a printing unit 1 according to the invention which is illustrated in its operative or printing position ready for use. A web offset press of the invention may comprise one or several of these units each aligned so as to work in unison with a paper web passing through each printing unit 1 into a folder (not shown).

The illustrated printing unit 1 is of a four-high configuration for four colour printing on both sides of the web. It therefore has eight print couples each comprising a plate cylinder 2 and a blanket cylinder 3. Each print couple is arranged in a pair disposed on opposite sides of the paper web 4 which runs between them so that the web 4 can be printed on both sides at the same time as it passes up through the print unit 1 from a reelstand (not shown) which may be mounted below or to one side of the print unit 1 at floor level.

An inking system 5 and a dampening system 6 is operatively associated with each print couple or, more specifically, the plate cylinder 2 of each print couple so as to supply ink and dampening solution thereto for printing. The inking and dampening systems 5,6 each comprises a train of rollers including forme rollers and ink distribution rollers. As the inking and dampening systems 5,6 are well known, no further description of their construction need be made here.

The printing unit 1 comprises a primary or central module 7 disposed between a pair of secondary or outer modules 8,9. The modules 7,8,9 are each mounted on a frame. As can be most clearly seen from FIG. 2, which illustrates the printing unit 1 of FIG. 1 in a non-operative partially open configuration for plate changing or maintenance, the plate and blanket cylinders 2,3 are rotatably mounted to the primary module 7 and the inking and dampening systems 5,6 are mounted to each of the secondary modules 8,9. Ideally, few other components apart from the plate and blanket cylinders 2,3 are mounted to the primary module 7 for reasons that will become apparent.

As can be seen from FIG. 2, the secondary modules 8,9 are movably mounted so that they may retract or slide laterally away from the primary module 7 and so that the axis of the cylinders 2,3 mounted to the primary module remains parallel to the axis of the rollers of the inking and dampening systems 5,6 mounted to the secondary modules 8,9 but the axis-to-axis distance between them increases as the secondary modules 8,9 are moved laterally away from the primary module 7. However, only one secondary module 9 is shown retracted from the primary module 7 in FIG. 2 but it will be appreciated that the other secondary module 8 may also retract to facilitate access to that side of the printing unit 1 as well.

As can be seen from the representation of a person 11 standing between the retracted secondary module 9 and the primary module 7 in FIG. 2, the secondary modules 8,9 may retract laterally away from the primary module 7 by a distance which enables a person to walk between the secondary and primary modules 7,8,9 to carry out various tasks such as cleaning, maintenance or plating-up of the printing unit either to the plate and blanket cylinders 2,3 in the primary module 7 or, to the inking and/or dampening systems 5,6 of the secondary modules 8,9. To facilitate these operations, the press may include an integral lift platform between each secondary module and the primary module which can rise to any height required to enable the whole printing unit to be serviced.

As the printing unit 1 opens up, it will be appreciated that access to all the components of the unit 1 is significantly improved. Furthermore, in conventional printing units that do not open up in the way described, access to the plate cylinders 2 for plating up operations must be made available from the outside of the printing unit, i.e. between the inking and dampening systems 5,6. This means that an access space must be provided between a print couple and the one situated directly above it. It also means that the inking and dampening units 5,6 are arranged so that their configuration of rollers extends in an angled direction away from the axis of the plate cylinder.

In the present embodiment of the invention, and as access to the plate cylinders 2 is obtainable via the space between the primary and secondary modules 7,8,9 when the secondary modules 9 are separated from the primary module 7, access from the outside of the printing unit 1 between the inking and dampening systems 5,6 is no longer required. Consequently, the print couples can be positioned much closer together in the vertical direction and the inking and dampening systems 5,6 can be located so that they extend substantially in a lateral rather than angled direction away from the axis of the plate cylinders 2. Therefore, the overall height of the print unit 1 is considerably reduced.

The reduction in the overall height of the print unit 1 facilitates access to upper parts of the print unit 1 and also reduces the height of the building required to contain it. Furthermore, the weight of the unit 1 is considerably reduced so the need for heavily reinforced foundations is also reduced.

As the distance between the print couples is reduced, the distance that the web 4 has to travel between points at which each colour ink is applied thereto also leads to improvements in registration, a reduction in the fan-out effect of the paper web 4 as well as reducing paper waste when the print unit 1 is made ready or is stopped between print runs or due to other problems requiring shut down of the print unit 1.

In a preferred embodiment, the primary module 7 and secondary modules 8,9 are mounted on a frame 50 which enables the secondary modules 8,9 to slide between an operative position, in which the inking units are in engagement with the print couples of the primary module 7 and, non-operative positions in which the inking units are spaced from the print couples for maintenance, plating-up operations and other functions. The construction of this frame 50 will now be described with reference to FIGS. 3,4 and 5 of the accompanying drawings.

Referring now to FIGS. 3 and 4, there is shown an end view of a secondary module support frame 50 and, a partial side view along the line X-X in FIG. 3, respectively. The support frame 50 comprises a carriage 51 to which one of the secondary modules 8,9 is immovably mounted and a bed 52. The carriage 51 is mounted on the bed 52 so that it can slide, in a perpendicular direction out of the page as shown in FIG. 3 or in the direction of arrow “R” (see FIG. 4) in which the secondary module is moving into engagement with the primary module and, in the direction of arrow “S” (see FIG. 4) in which the secondary module is moving out of engagement with the primary module, in response to the operation of a stepper motor 53 (only part of which is shown in FIG. 4). The primary module 7 is mounted to a primary module base part 54, only a part of which is illustrated in FIG. 4.

The bed 52 comprises a pair of secondary module base parts 55 spaced from each other by a distance substantially equal to the length of the secondary module 8,9 and connected by a bracing strut 56. Each secondary module base part 55 has feet 57A to firmly support it on a level surface and each foot 57A is adjustable to enable the bed 52 to be levelled accurately.

The carriage 51 comprises a pair of secondary module support members 57, 58 to which the secondary module 8,9 is immovably mounted and which are connected via a bracing arm 59 which is essentially the same length as the bracing strut 56. Each support member 57,58 is mounted on one of the secondary module base parts 55 so that the carriage 51 can slide together with the secondary module 8,9 on the base parts 55.

Each secondary module support member 57,58 is mounted to the bed 52 via a pair of slide units 60 attached to the underside of each secondary module support member 57,58 which locate on elongate guide tracks 61 attached to each of the base parts 55 (only one slide unit 60 being shown on the secondary support member 55 shown in FIG. 4). An enlarged end view of a portion of the support frame 50 showing the slide units and guide track 61 is illustrated in FIG. 5. Each slide unit 60 contains a set of pre-loaded linear roller bearings (not shown) which locate in guide recesses 62 on the guide track 61.

As mentioned above, the secondary module 8,9 is movable into and out of engagement with the primary module 7 in response to the operation of motor 53 and a drive mechanism which causes the secondary module to move will now be described. As shown in FIG. 4, the drive mechanism comprises a drive transmission unit 63 comprising a housing 64 (not shown in FIG. 3), containing a first pulley 65 rotatably driven by the motor 53 and a second larger pulley 66 which is drivingly connected to the first pulley 65 via a drive belt 67. The second pulley 66 is located on the end of a ball screw 68 which extends along the inner side of one of the base parts 55 and rotates together with the second pulley 66. The ball screw 68 is mounted in bearing support members 69 at each end where it is supported on the bed 52.

The ball screw 68 extends through and is coupled to a connecting member 70 which is attached to one of the secondary module support members 58 such that, as the ball screw 68 rotates, the connecting member 70 is driven along the ball screw 68 thereby forcing the carriage 58 to slide along the guide tracks 61 in either direction “R” or direction “S” depending on the direction of rotation of the motor 53.

It will be appreciated that the aforementioned arrangement enables the position of the secondary module 8,9 to be precisely controlled using the stepper motor 53 and without any backlash. An encoder 71 may be located at the end of the ball screw 68 to enable the exact position of the secondary module 8,9 to be determined. Alternatively, the encoder can be associated with the drive motor to perform the same function.

It will be appreciated that only one support frame 50 is shown in the drawings. However, another support frame 50 is located on the other side of the primary module base part 54, i.e. to the left of the partial view of the primary module base part 54 shown in FIG. 4, to enable independent movement of the other secondary module 8,9 towards and away from the primary module 7. A complete view of the support frame 50 together with the primary and secondary modules 7,8,9 thereon is also shown in FIG. 18.

In the aforementioned arrangement, the primary module 7 is immovably mounted on the primary module base part 54. However, it will be appreciated that the means for moving the secondary modules 8,9 could also be employed for moving the primary module 7.

Each secondary and primary module 7,8,9 may include means for locking them together when the secondary modules 8,9 are in their operative positions and the print unit 1 is ready for printing. The locking means (not shown) may comprise a spring applied, hydraulically released disc brake calliper attached to the frame of the primary module 7 and a plate attached to the secondary module 8,9 which is received within the calliper when the secondary module 8,9 is moved into its operative position.

Although the print unit 1 has been described as having secondary modules 8,9 which retract sufficiently to enable a person 11 to gain access between each secondary module 8,9 and the primary module 7, it will be appreciated that it is not necessary to provide means to enable the secondary modules 8,9 to move to such an extent. For example, when an automatic plate changing mechanism is employed, the secondary modules 8,9 only need to move a distance from the primary module 7 sufficient to enable the plate changing mechanism to pass between each secondary module 8,9 and the primary module 7. It is envisaged that the plate loading mechanisms will also be fully automatic and can deliver a set of plates to each print unit and install them automatically. The plates will be loaded into automatic plating up modules off-line which will then be delivered to the press either manually or by an automatic transportation system. The plate changing modules will locate themselves between the primary and secondary modules 7,8,9 and install the plates onto the cylinders automatically. Similarly, other robotic or automatic sub-systems may be employed such as automatic cleaning to clean both the blankets and the ink trains, unit setting machines capable of checking forme roller to plate cylinder flat settings or on-press imaging systems capable of introducing direct imaging to the plate cylinders. These automatic modules may therefore avoid the need to move the secondary modules 8,9 by a distance sufficient to enable a person to gain access between the secondary and primary modules 7,8,9. It is also envisaged that on-press imaging technology may be employed to laser engrave a re-writable plate on the cylinder. As access to the plate cylinder 2 is made easy when the inking and dampening systems 5,6 are moved out of engagement with the plate cylinder 2, the engraving equipment can be located in the space between the primary and secondary modules 7,8,9 and subsequently removed before the secondary modules 8,9 are returned to their operative positions.

The ability to split the printing unit 1 also simplifies the construction and therefore the cost of many of the sub-systems referred to in the previous paragraph because they no longer need to be designed so that they can access, for example, the plate cylinders between other components of the printing unit such as the inking and dampening systems.

As an alternative to moving each of the secondary modules 8,9 laterally away from the primary module 7 in opposite directions, it will also be appreciated that the printing unit 1 could be arranged so that only one secondary module 9 and the primary module 7 move laterally away from the remaining secondary module 8 in the same direction so as to separate the primary and secondary modules 7,8,9.

A further modification of the printing unit according to the aforementioned embodiment of the invention will now be described. This modified embodiment enables the plate and/or blanket cylinders to be changed quickly and easily for cylinders of the same or different diameters thereby enabling the printed image cut-off to be changed. As the cut-off depends on the diameter of the plate and blanket cylinders, they must be replaced with cylinders having a different diameter to enable the cut-off to be altered to suit the required print job. In addition to facilitating the alteration of the printed image cut-off by changing the plate and blanket cylinders, this modification also simplifies general maintenance and other tasks such as plating up, changing blankets and setting rollers.

Rather than physically remove the plate and blanket cylinders from the primary module, the present invention realises that because the unit separates into three modules, one of which contains the plate and blanket cylinders and very few or no other major components of the printing unit, it is possible to replace the primary module as a whole with another primary module stored off-line by moving it, when the secondary modules are in their retracted non-operative positions, and replacing it with another primary module, using either an automatic or manual transportation system. The new module can have an entirely different set of plate and blanket cylinders. However, the secondary modules containing the inking and dampening systems are reused with the new primary module and can be moved back so that the inking and dampening systems become operatively associated with the plate cylinders of the new primary module so that the printing unit is rapidly made fully operational again. The old primary module is now stored off-line until its use is required once again or it is moved into an appropriate location for maintenance, repair or plate changing.

To enable the primary module to be moved or changed, it is mounted on a slideway such as on rails so that it can be slid from a first position in which it can be operatively associated with the secondary modules for printing to a second storage or maintenance position off-line in which it is no longer between the secondary modules. The primary module may be movable in a lateral direction which is substantially at right angles to the lateral direction of movement of the secondary modules when they move between their operative and non-operative positions. The printing unit may be arranged so that as one primary module is moved out of its printing position another module stored off-line moves between the secondary modules so as to take its place.

It will be appreciated that as the whole primary module is completely replaced with a different module, the printing unit can be quickly and easily brought back on-line as soon as the secondary modules have been returned to their operative positions. Therefore, maintenance, plate changing or cleaning of one primary module can be carried out whilst the printing unit is operational with another primary module.

It will be appreciated that each printing unit may be provided with two or more primary modules. Alternatively, a printing press employing a number of printing units may be provided with any number of primary modules which may be stored off line either adjacent to the press or in a magazine rack alongside the press. Depending on the layout of the track to which the primary modules are mounted, they may be moved, for example, between one or more printing units or taken into another room for more in-depth maintenance or setting up. It will be apparent that in an ideal configuration, the press is provided with a larger number of primary modules than there are print units so that it will always be possible to keep the entire press running even when one or more modules is off-line for maintenance and repair.

When this modified arrangement is used, it will be appreciated that the secondary modules need only move laterally away from the primary module by a distance sufficient to enable the primary module to move out from between the secondary modules as any maintenance to the primary and/or secondary modules can be conducted once the primary module has been moved. However, it may be preferable to enable the secondary modules to move by a greater distance to enable maintenance and other tasks to be carried out whilst the primary module remains in situ.

The primary module can have slide units containing pre-loaded roller bearings attached to its underside which are slideably located on guide tracks mounted on a support base. This mounting arrangement is therefore similar to the way in which the secondary modules are mounted to their supporting bases. However, the means for moving the primary module may be different. Instead of a ballscrew and motor arrangement, the press will include a bogie or truck which may run on a track and slide underneath the primary module. Once underneath, one or more hydraulically operated pins on the bogie will cooperate with an aperture in the underside of the primary module so that, when the bogie moves it drags or pushes the primary module along the guide tracks. The bogie may drag the primary module off its support base and onto a transfer pallet. Once on the transfer pallet, the bogie releases its connection with the primary module so that the primary module is now seated on the transfer pallet. The transfer pallet may move by any known means such as, for example a rack and pinion system, and is operable to take the primary module to any desired location or parking position. The pallet may then pick up another primary module from a different location in the same way and transfer it back to the printing unit to enable printing to be continued with the replacement primary module.

A plan view of one print unit having two primary modules 7a,7b according to the modified version of the invention is illustrated in FIG. 6. In this simplified arrangement, it can been seen that the secondary modules 8,9 are configured so that they can each move from their operative positions laterally away from the primary module 7a in opposite directions (the secondary module 8 moves in the direction indicated by Arrow A, whereas the other secondary module 9 moves in the direction indicated by Arrow B) so that they become separated from the primary module 7a. Once the primary module 7a is free from the secondary modules 8,9, the primary module 7 itself can then slide out from between the secondary modules 8,9 to the position shown in dashed lines (the primary module 7a moves in the direction indicated by arrow C). At the same time or after movement of the primary module 7a, an additional primary module 7b located off-line takes the place of the primary module 7a by also moving in the direction of arrow C. The secondary modules 8,9 can then be moved back so that they operatively engage with the new primary module 7b. The print unit 1 can then be operated with the additional primary module 7b whilst the maintenance, plating up, cleaning or other tasks are performed on the now off-line primary module 7a.

Although this aspect of the invention is primarily concerned with the ability to substitute the primary module, it is also envisaged that the printing unit or press may include at least one spare secondary module so that maintenance or repair to one secondary module can be carried out whilst the printing unit continues to operate with a different secondary module. It is also possible to provide another pair of secondary modules adjacent to the first pair so that the primary module can slide out from between the first pair into a space between the second pair. The second pair of secondary modules can then be brought into an on-line position with the primary module.

It will be appreciated that in a printing press having a number of printing units, all of the units may have a similar configuration. In a more complicated arrangement, each printing unit may have several primary modules associated with it so that one can be selected depending on the print task to be carried out and the printed image cut-off required. Alternatively, the press may be provided with a plurality of primary modules any one of which may be used with any one of the print units of the press.

In a conventional printing unit, the rubber covered ink form rollers and water form rollers forming part of the inking and dampening systems are held pressed against their respective plate cylinders with a predetermined pressure so that a “flat” is generated in the rubber surface of these rollers. It is important that the flat region is accurate and parallel across the cylinder and adjustable stops are provided on the printing unit against which an arm at each end of the forme rollers engages to hold the forme rollers in the correct position against the plate cylinder. The form rollers can be thrown on and off the plate cylinder by hydraulic or pneumatic mechanisms which allow them to move by approximately 6 mm which is just enough to bring the forme rollers out of contact with the plate cylinder. However, in the present invention, the forme rollers are mounted to the secondary modules so that they can move through a much greater distance to accommodate plate cylinders having different diameters, i.e. different cut-offs. Each of the primary modules will have a stop member mounted on the primary module in a position corresponding to the cut-off of the plate cylinders of that module and against which the arms on the forme rollers will engage, when the secondary module is brought into engagement with a primary module, so as to maintain the same size of flat irrespective of the diameter of the plate cylinder.

As already mentioned above, the folder must also be modified each time a primary module is changed for another primary module having cylinders operable to print with a different image cut-off. As can be seen from FIG. 10, a folder according to an embodiment of the invention generally comprises three sections namely, an upper folder module 50, a lower folder module 51 and a delivery module 52. The upper folder module 50 comprises at least one former 53 (two are shown in FIG. 10) which imparts a first longitudinal fold to the ribbons 54 as they travel over it and a plurality of nipping rollers 55. There are generally two different types of lower folder and these are usually referred to as a jaw folder and a rotary folder, respectively. A jaw folder, as shown in FIG. 10, comprises a collect cylinder 56 to collect the ribbons 54 as they leave the or each former 53, a cutting cylinder 58 which cuts the ribbons 54 into longitudinal sections defined by the height of the page and a jaw cylinder 57 which imparts a second fold to the cut sections substantially at right-angles to the fold imparted to the ribbons 54 by the or each former 53. A rotary folder (not shown) comprises a folding cylinder and second fold rollers together with a cutting cylinder to perform the same function.

The cut sections or newspapers pass from the folder module 51 into the delivery module 52 comprising a rotatably mounted paddle wheel 59 which delivers the newspapers to a conveyor 59a with an appropriate copy spacing for stacking and bundling by post-press machinery. The delivery module 52 also includes a stripper (not shown) situated between the paddle wheel 59 and the conveyor 59a which runs slower than the paddle wheel but at the same speed as the conveyor 59a. The stripper pushes copies out of the paddle wheel 59 and onto the conveyor 59a.

The cylinders 56,57,58 of the lower folder module 51 are all cut-off dependent which means that when the cut-off is changed, each of the cylinders 56,57,58 must be replaced with cylinders having a different diameter corresponding to the new cut-off. Therefore, if the primary modules 7 of the printing units are replaced to alter cut-off, the cylinders 56,57,58 of the lower folder module 51 must also be replaced.

Therefore, according to another aspect of the invention, rather than physically remove the cylinders from the lower folder module 51 and replace them, the lower folder module 51 is configured to be discrete and separable from the upper folder module 50. The lower folder and delivery modules 51,52 may be combined into one integral or common frame. However, more preferably, the delivery module 52 is also discrete and separable from the lower folder module 51. The delivery module includes the paddle wheel 59 and, preferably, includes the stripper and the conveyor. However, it may just comprise the paddle wheel 59.

Therefore, as with the primary module 7 of each of the printing units 1, the lower folder module 51 together with its cylinders 56,57,58 forms an entirely separate part which may be removed from the folder as a whole and replaced with another folder module 60 (see FIG. 11) stored in an off-line location and which may be assembled together with cylinders 56,57 having a diameter corresponding to the required new cut-off size. The lower folder module 51 and the delivery module 52 may be mounted on slideways to enable them to be moved between operative positions in the folder and non-operative off-line positions. In the plan view of FIG. 11, the lower folder module 51 is shown in its operative position in which it is connected to the upper folder module 50 (not shown in FIG. 11) and to the delivery module 52. The lower folder module 51 can be separated from the folder and moved in the direction indicated by arrow Y to an off-line storage position shown in dashed lines and can be replaced with another lower folder module 51a by moving it in the direction indicated by arrow Z.

If the folder comprises a delivery module 52, the same delivery module 52 can be used with any lower folder module 51 irrespective of its cut-off size and even with folding modules that use different folding actions. It is also much easier to alter the relative position of the lower folder module 51 and the delivery module 52 to optimise the transfer of copies from the lower folder module 51 to the delivery module 52. The lower folder module 51 and the delivery module 52 each have their own side frames 65,66 to which the components of the respective module 51,52 are mounted. Preferably, the side frames 66 of the delivery module 52 are spaced closer together than the side frames 65 of the lower folder module 51 so that the delivery module 52 can be slid partially inside the lower folder module 51 in its operative position. The delivery module 52 can also be easily slid out of engagement with, or retracted away from, the lower folder module 51 to facilitate access to the lower folder module 51 and the delivery module 52 for maintenance and repair or replacement of one or both of them.

It will be appreciated that the paddle wheel 59 and stripper of the delivery module 52 delivers copies to the conveyor 59a with a predetermined fixed copy spacing for stacking and bundling by post press machinery. However, various customers often require copies to be delivered with different copy spacing. To change the copy spacing of a conventional folder, the paddle wheel 59 and stripper must be substituted for another of a different configuration. However, in the present invention, instead of having to disassemble the delivery module 52 to replace the paddle wheel 59 and stripper, the whole delivery module 52 can be quickly and easily replaced with another module 52 having a paddle wheel capable of delivering copies with the required copy spacing.

It is common practice to install a back-up lower folder next to a primary lower folder so that in the event of a failure of one unit, production can be switched to the other. If the folder is provided with a separable delivery module 52, only one delivery module 52 is required and can be used with either of two lower folder modules 51. Alternatively, if there are two delivery modules 52, each delivery module 52 can be used with either lower folder module 51.

It will be appreciated that some of the aforementioned advantages such as access to the lower folder unit and substitution of the delivery module 52 can be achieved without the need for a separable lower folder module 51. Therefore, in accordance with another aspect of the invention, there is a folder having an integral upper and lower folder comprising modules 50,51 and only the delivery module is separable from the rest of the folder. In either arrangement, it is proposed that the delivery module 52 incorporates its own motor for driving the paddle wheel 59 and, preferably, the stripper and the conveyor.

A printing press according to another aspect of the invention will now be described. The press according to this aspect of the invention may be used with the printing units and folder described with reference to the earlier embodiments. However, it will be appreciated that the following press configuration may also be employed with other conventional printing units, presses and folders.

In order to describe this aspect of the invention, a simplified plan view of a conventional press layout is illustrated in FIG. 7. It can be seen, for the purposes of this embodiment, that the press comprises four print units 13a,13b,13c and 13d and a folder 14 having two formers 14a and 14b. A pair of print units are located on opposite sides of the folder 14 and the paper web from each print unit 13a to 13d travels upwardly through each print unit 13a to 13d and then laterally across (as indicated by the arrows X) and then down into the folder 14 via a slitting mechanism (not shown) to cut the web into separate ribbons travelling side by side and a turner bar module 15 which is used to turn one of the ribbons so that both ribbons overlap and enter the same former 14a or 14b of the folder 14. The uppermost pair of print couples each comprising a plate and blanket cylinder 2,3 can be seen in each print unit 13 from which it will be apparent that the plane of the web as it emerges from the print unit and the plane of the web as it enters the folder 14 are parallel.

The problem with a printing press configured in accordance with the illustration has already been mentioned above and occurs when the web is slit so as to form a plurality of ribbons which must then be fed through the same former 14a or 14b in the folder 14, as opposed to each ribbon being fed through a separate former to form two or more separate newspaper sections side-by-side. When the web is slit, the ribbons so formed are travelling together in the same plane in a side-by-side relationship. Therefore, the relative positions of the ribbons must be changed so that they are no longer travelling in the same single side-by-side plane but instead travel in different parallel planes lying one above the other or in an overlapping relationship. Although the relative positions of the ribbons are changed by the turner bars 15 disposed adjacent to the folder 14 not all of the ribbons are turned or not all of them are turned the same number of times. It therefore becomes very difficult to control the web tension in each ribbon. Any differences in web tension between the ribbons makes it difficult to ensure that the ribbons remain in register. The alignment or registration of the ribbons is important, particularly so when so-called “split double” printing is carried out and in which a photograph or other matter is printed so that it extends across two separate pages of a tabloid newspaper each of which may be on a different ribbon.

The modified arrangement is illustrated in FIG. 8 from which it can be seen that each of the print units 13a to 13d have been turned through 90 degrees so that the plane of the web as it travels in a vertically upward direction through each print unit 13 is at right angles to the plane of each of the ribbons as they travel downwardly into the folder 14 through one of the formers 14a or 14b, as will be apparent from the position of the uppermost pair of plate and blanket cylinders 2,3. As will be explained, turner bars 15 are used to turn the plane of all the ribbons through 90 degrees so that they are aligned with the folder 14 and travel in the direction indicated by the arrows X2 in FIG. 8. A slitting mechanism and turner bar module is mounted on and directly above each print unit 13 so that the web is slit and turned soon after it exits each print unit rather than just before the ribbons enter the folder. The turner bar module or slitting mechanism are not shown in FIG. 8 for clarity. Alternatively, the turner bars 15 and slitting mechanism (not shown) may be located adjacent to each print unit 13 so that the webs are turned to be in line with the folder 14 which is offset from the print units 13, as shown in FIG. 9, and in which the movement of the web from each print unit 13 to the folder is indicated by the arrows X3.

Reference to the prior art arrangement of FIG. 12 of the accompanying drawings will now be made together with FIG. 13 which illustrates the modified arrangement according to the invention. For simplification, the web in both drawings has been slit once so as to form two separate ribbons. However, it will be appreciated that the web may be slit any number of times as required.

Referring to the genetalised perspective view of FIG. 12, a section of the web 4 can be seen travelling in a vertically upward direction (in the direction of arrow F) as it leaves the print unit (not shown). The web is passed over a roller 16 whose axis is parallel to the plane of the web 4 and which turns the web 4 through 90 degrees so that it is now travelling in the direction indicated by arrow G in a lateral direction which is directly towards the folder 14.

A mechanism 17 for slitting the web so as to form two separate ribbons 18,19 travelling side-by-side is disposed adjacent to the folder 14. Once the web 4 has been slit, one of the ribbons 19 is passed over a pair of further rollers 20,21 both of which have their axes parallel to the plane of the ribbon 19 so that the ribbon 19 travels in a downward direction and then in a lateral direction once again in the directions indicated by arrows H and I respectively. The same ribbon 19 is then passed over first and second turner bars 15a,15b having their axes at 45 degrees to the plane of the ribbon 19. When the ribbon 19 has passed over the second turner bar 15b, it can be seen that it is now travelling directly beneath in a parallel plane and in the same direction as the remaining ribbon 18 which remains on the same path after passing over the first roller 16. Therefore, as one ribbon 19 is passed over rollers 20,21 and turned twice over turner bars 15a,15b whereas the other ribbon 18 passes straight into the folder 14 without being turned, the relative tension between the two ribbons 18,19 is likely to be different leading to well-known runability and registration problems.

The present invention overcomes this problem and provides an arrangement in which the ribbons are positioned in parallel planes one above the other by ensuring that both the ribbons are turned the same number of times. Referring to FIG. 13, the web 4 can be seen travelling in a vertically upward direction from the print unit in the direction of Arrow F as before. However, as described with reference to FIG. 8, the print unit has been rearranged so that the plane of the web 4 now lies at an angle of 90 degrees relative to the plane of the ribbons as they enter the folder 14.

As the web 4 travels in its vertically upward path from the print unit, it is slit by a slitting mechanism 17 to form two ribbons 22,23 both travelling vertically side-by-side in the same plane. Each ribbon 22,23 is then passed over separate rollers 24,25 at different heights both of which have their axes at right angles to the direction of travel of the ribbons 22,23. As the ribbons 22,23 pass over the rollers 24,25 they are turned through 90 degrees so that they are now both travelling in a lateral direction side by side but at different heights in the direction indicated by arrow J. Both ribbons 22,23 now need to be turned so that they are travelling towards the folder 14. This is achieved by passing each ribbon 22,23 over a turner bar 26,27 having their axes aligned at 45 degrees to the direction of travel of each ribbon 22,23. The lower turner bar 26 is located in front of but lower than the upper turner bar 27 so that when the ribbons 22,23 are turned, both ribbons 22,23 are travelling towards the folder with the lower ribbon 22 beneath the upper ribbon 23 as is required. The turner bars 26,27 are mounted in a turner bar module 26a above each print unit 1 (see FIGS. 1 and 2).

It will be appreciated that because the print unit is arranged so that the plane of the web is at an angle when it exits the print unit relative to the plane of the web as it enters the folder, all the ribbons rather than just some of them must be turned. Furthermore, all of the ribbons are turned the same number of times so that the tension between each of the ribbons can be controlled and maintained substantially equal.

In another modified arrangement, the turner bars can be arranged so that two or more ribbons travelling side-by-side are not touching but ate separated by a gap. This allows for a constant former position regardless of web width, thereby simplifying the upper folder module. The provision of ribbon compensators at the turner bars also permits every ribbon to be registered correctly within the newspaper without the use of section registers within the upper folder module. This also simplifies the upper folder and improves the runability of the press.

It will be appreciated that the aforementioned embodiment relating to an arrangement of a printing press can be used in conjunction with none, some or all of the previously described embodiments to provide a particularly flexible printing press. Some examples of proposed printing press layouts incorporating all the aforementioned embodiments will now be described with reference to FIGS. 14 to 16 of the accompanying drawings.

Referring to FIG. 14, there is shown a plan view of a possible printing press configuration which embodies all aspects of the invention namely, the retractable modules on each printing unit, the movable and replaceable primary modules, the removable and replaceable lower folder modules and delivery modules and the alteration of the orientation of each printing unit relative to the folder.

There is shown in FIG. 14 a plan view of a press having four printing units marked C1 and a folder marked F1. Each printing unit C1 has a pair of secondary modules indicated by the letter “I” to which are mounted the inking and dampening systems 5,6. These ate shown in a position following separation from primary modules C1. Each print couple in each of the printing units C1 is provided with its own motor 30. Only the motors 30 driving the uppermost pair of print couples can be seen in the drawing. The inking and dampening systems 5,6 of the secondary modules I are also each provided with their own motor 31 and again, only the uppermost motor of each secondary module I can be seen in the plan view of FIG. 14.

It will be appreciated that the printing units are arranged in accordance with the aspect of the invention described with reference to FIG. 8 so that the web passes vertically upward through each print unit in a plane at tight angles to the plane in which the web lies as it passes downwardly into the folder F1.

On the left hand side of the folder F1 beyond two of the printing units as viewed in the drawing, there is shown a row 32 of four additional primary modules each stored in an off-line position. These are marked C2 and C3. Any one of these modules may take the place of one of the primary modules C1 on the left hand side of the folder F1. The primary module C1 which is to be replaced may be moved into an off-line position in the row in the place indicated by dashed lines which is marked C1′. A similar row 33 is shown on the right hand side of the folder as viewed in the drawing. The dashed lines 33 between the primary modules C1 and the primary modules stored off-line marked C2 and C3 are symbolic of a track or slideway along which the primary modules C1,C2,C3 may be moved between their storage positions and operational positions between the secondary modules using an automatic or manual transportation system such as the system described in more detail above.

A second similar configuration is illustrated in FIG. 15 except that, in this drawing, the primary modules are stored off line in two rows 32a,32b at either end of the press. This arrangement may be more appropriate when the width of the press room is not sufficient to accommodate a single storage row 32.

It will be appreciated that the storage facility for the primary modules situated off-line may be separated from the press room by a dividing wall with an opening therein to allow movement of the primary modules to and from the press. This enables the modules to be plated up or otherwise worked on in a controlled environment different to the environment occupied by the working press.

In FIGS. 14 and 15, it can be seen that folder F1 includes two additional folder modules F2,F3 stored in an off-line location. Either of these modules F2,F3 can replace the folder module F1 currently in an operative position to facilitate cut-off change of the folder cylinders when the cut-off of the cylinders of the primary modules C1 of each printing unit is changed by replacing the primary module C1 with primary module C2 or C3 each having a different cut-off. Each folder module can be moved to an off-line position when replaced with a different folder module F2,F3.

Yet another possible configuration is illustrated in the cross-sectional view of FIG. 16. In this arrangement, instead of providing the storage facilities for the primary modules at floor level, the primary modules are stored at a lower or sub-level basement area 34. It is envisaged that the modules C1, C2, C3 may be mounted on a slideable carousel or turntable 35 movable in the direction of arrow S so that a required primary module C1 is positioned between but below the secondary modules I. The primary module can then be winched up or hoisted into position between the secondary modules I in the direction of arrow T. The reelstand 36, which is normally mounted directly beneath the print unit, is offset in this configuration in order to allow sufficient space to accommodate the stored primary modules C1,C2,C3.

In a modified version of the FIG. 15 arrangement, which could also be applied to the arrangement of FIG. 14, there is shown in FIG. 17 a printing press in which the reelstands R1 are mounted alongside the secondary modules I rather than below each of the printing units. A side view of one of the printing units together with a reelstand adjacent to it is illustrated in FIG. 18. It will be noted that the primary and secondary modules 7,8,9 are mounted on a bed 52 to enable the secondary modules 8,9 to be slid between their operative and non-operative positions, as described in more detail above with reference to FIGS. 3 to 5. The path of the paper web from the reelstand through the printing unit is also shown.

It will be appreciated from the foregoing that each aspect of the invention provides an advantage which may be used independently or together in a printing press to provide a flexible, easy to maintain and install system that can be used for high volume commercial printing, such as in the printing of newspapers.

Many modifications and variations of the invention falling within the terms of the following claims will be apparent to those skilled in the art and the foregoing description should be regarded as a description of the preferred embodiments only.

1. A multi-colour printing unit for a web-offset press comprising a plurality of printing couple pairs, each printing couple of said printing couple pairs comprising a plate and blanket cylinder and each printing couple pair being arranged so as to print a different colour on both sides of a paper web passing between the printing couples of each pair, and an inking system associated with each print couple operable to supply ink to the plate cylinder thereof in an operative position, wherein the printing unit comprises a primary module carrying all the printing couple pairs and a pair of secondary modules carrying the inking systems, the secondary modules being movable into a non-operative position in which the primary and the secondary modules are separated from each other, characterised by means for moving the primary module out from between the secondary modules when the secondary modules are in their non-operative positions and separated from the primary module to enable a second primary module, comprising a plurality of printing couple pairs in which the plate and blanket cylinders are of a different diameter to the diameter of the plate cylinders of the original primary module to take the place of the original primary module so that the secondary modules can be moved back into an operative position with said second primary module.

2. A printing unit according to claim 1, wherein the primary module is disposed between the pair of secondary modules.

3. A printing unit according to claim 1, wherein the or each secondary module is slideable in a lateral direction away from the primary module to separate the printing unit into said primary and secondary modules.

4. A printing unit according to claim 3, wherein each of the secondary modules are slideable laterally away from the primary module in opposite directions.

5. A printing unit according to claim 3, wherein the secondary modules are slideably mounted on a supporting base.

6. A printing unit according to claim 5, wherein a slide unit is attached to each of the secondary modules for cooperation with a guide track on the supporting base.

7. A printing unit according to claim 6, wherein the slide unit includes pre-loaded roller bearings that cooperate with a recess on the guide track.

8. A printing unit according to claim 6, wherein the secondary modules include a carriage to which they are immovably attached, the slide units being mounted on the carriage.

9. A printing unit according to claim 6, including means for driving said carriage along the track.

10. A printing unit according to claim 9, wherein the drive means includes a motor drivingly connected to a ball screw mounted to the supporting base and a connecting member on the ball screw attached to the secondary module such that the secondary module slides on the supporting base in response to rotation of the ball screw by the motor.

11. A printing unit according to claim 10, wherein the motor is connected to the ball screw via a pair of pulleys and a drive belt.

12-14. (canceled)

15. A printing unit according to claim 1, including a plurality of additional primary modules, said means enabling the primary module located between the secondary modules to be replaced with a selected one of said plurality of additional primary modules when the secondary modules are moved into their non-operative positions.

16. (canceled)

17. A printing unit according to claim 16, comprising a cooperating adjustment mechanism on the primary and secondary modules so that the inking systems adjust to plate cylinders of different diameters when the secondary modules are returned to their operative positions.

18. A printing unit according to claim 12, wherein said means for moving the primary module includes a slide member on the primary module which cooperates with a guide track attached to a supporting base on which the primary modules sits in an operative position.

19. A printing unit according to claim 18, wherein said means further includes a transfer bogie which cooperates with the or each primary module to push it along the guide track onto a transfer pallet.

20. A printing unit according to claim 1, wherein dampening systems are mounted to each of the secondary units.

21. A method of reconfiguring a multi-colour printing unit for a web-offset press comprising a plurality of printing couple pairs each printing couple of said printing couple pairs comprising a plate and blanket cylinder and each printing couple pair being arranged so as to print a different colour on both sides of a paper web passing between the print couples of that pair, and an inking system associated with each print couple operable to supply ink to the plate cylinder thereof in an operative position, wherein the printing unit comprises a primary module carrying all the printing couple pairs and a pair of secondary modules carrying the inking systems, the method including the step of moving the secondary modules into a non-operative position in which the primary and the secondary modules are separated from each other, characterised by the step of moving the primary module out from between the secondary modules when the secondary modules are in their non-operative positions and moving a second primary module comprising a plurality of printing couple pairs in which the plate and blanket cylinders are of a different diameter to the diameter of the plate cylinders of the original primary module, into the position previously occupied by the original primary module and, moving the secondary modules back into an operative position with the second primary module.

22. A method according to claim 21, wherein the method includes the step of moving the primary module out from between the secondary modules when the secondary modules have been moved into the non-operative position.

23. A method according to claim 22, wherein the method includes the step of moving the primary module in a direction substantially at right angles to the direction of movement of the secondary modules between their operative and non-operative positions.

24. A method according to claim 22, wherein the method includes the step of moving a different primary module stored remote from the secondary modules to between the secondary modules and returning the secondary modules to their operative positions with said different primary module.

25. A method according to claim 24 wherein the printing unit comprises a plurality of different primary modules stored remote from the secondary modules and the method includes the step of selecting one of said different primary modules and moving said selected primary module to between the secondary modules and returning the secondary modules to their operative positions with said selected primary module.

26. A method according to claim 24, including the step of replacing the primary module with a primary module carrying plate cylinders of a different diameter to the diameter of the plate cylinders carried by the primary module that is being replaced.

27. A folder for a web-offset printing press comprising an upper folder module including at least one former to impart a first longitudinal fold to a continuous web of printed matter passing over the or each former, a lower folder module to receive the folded web from the upper folder module and comprising means to cut the web into longitudinal sections and impart a second fold to each section substantially at right angles to the first longitudinal fold and, a delivery module comprising means to receive the folded sections from the lower folder module and deliver them for transportation out of the folder, characterised in that the delivery module is discrete and separable from the lower folder module.

28. A folder according to claim 56, wherein the lower folder module comprises a frame to which said means are mounted, the frame including cooperating means to releasably attach it to the upper folder module in an operative position.

29. A folder according to claim 56, wherein the lower folder module is a jaw folder and comprises a collect cylinder, a jaw cylinder and a cutting cylinder.

30. A folder according to claim 56, wherein the lower folder module is a rotary folder module and comprises a folding cylinder, second fold rollers and a cutting cylinder.

31. A folder according to claim 30, wherein the diameter of the respective cylinders of each lower folder module are different.

32. A folder according to claim 56, wherein the frame includes means to enable the lower folder module to be moved from its operative position to an off-line storage position.

33. A folder according to claim 32, wherein said means for moving the lower folder module includes means to enable a different lower folder module to be located in said operative position in place of the lower folder module.

34. A folder according to claim 32, wherein the folder includes at least two lower folder modules, each module movable between the operative position in the folder and an off-line storage position.

35. (canceled)

36. A folder according to claim 56, wherein the delivery module comprises a frame and cooperating means to releasably attach the frame to the lower folder module in an operative position.

37. A folder according to claim 56, wherein the means in the delivery module to receive the folded sections from the lower folder and deliver them for transportation out of the folder comprises a rotatably mounted paddle wheel.

38. A folder according to claim 37, wherein the delivery unit further comprises a stripper and a delivery conveyor to receive folded sections from the paddle wheel and transport them from the folder.

39. A folder according to claim 37, wherein the paddle wheel is rotatably driven by its own motor.

40.-44. (canceled)

45. A folder according to claim 39, wherein the motor of the paddle wheel is mounted to the delivery module.

46. A method of reconfiguring a folder for a web-offset printing press comprising an upper folder module including at least one former to impart a first longitudinal fold to a continuous web of printed matter passing over the or each former, a discrete lower folder module separable from the upper folder module to receive the folded web from the upper folder module and comprising means to cut the web into longitudinal sections and impart a second fold to each section substantially at right angles to the first longitudinal fold and, a delivery module comprising means to receive the folded sections from the lower folder module and deliver them for transportation out of the folder, wherein method includes the step of separating the lower folder module from the upper folder module and replacing the lower folder module with another lower folder module, the method being characterised by the step of separating the delivery module from the lower folder module and re-attaching the delivery module to said other lower folder module.

47. A printing press including a plurality of printing units according to claim 1.

48. A printing press including a folder according to claim 27.

49.-51. (canceled)

52. A web-offset printing press comprising a plurality of print units and a folder located adjacent to the print units, each print unit defining a path for a web of paper passing that passes through the press each print unit and into the folder, each print unit comprising means for slitting the web to form a plurality of ribbons and means for turning each of said ribbons the same number of times between the print unit and the folder so that each ribbon lies in a parallel plane one above the other as they travel towards and into the folder, wherein the print units are arranged so that all the webs lie in substantially the same plane as they pass through their respective printing units prior to being slit into ribbons.

53. A web-offset printing press according to claim 52, wherein the press is configured so that the web passing up through the print unit lies in a plane at right angles to the plane occupied by each of the ribbons as they pass down into the folder.

54. A web-offset printing press according to claim 52, wherein the printing unit comprises print and blanket cylinders arranged to rotate about first parallel axes and the folder comprises cylinders arranged to rotate about second parallel axes, the first and second axes being at right angles to each other.

55. A web-offset press according to claim 52, comprising a plurality of print units each having means for slitting the web passing through a print unit to form a plurality of ribbons and each having means for turning said ribbons so that the ribbons from each print unit lie in a parallel plane one above the other as they travel towards and into the folder.

56. A folder according to claim 23, wherein the lower folder module is discrete and separable from the upper folder module.
